(19) United States
(12) Patent Application Publication
(10) Pub. No.: US 2007/0129942 A1
(43) Pub. Date: Jun. 7, 2007

(54) Visualization and annotation of the content of a recorded business meeting via a computer display

(76) Inventors: Oliver Keren Ban, Austin, TX (US); Timothy Alan Dietz, Austin, TX (US); Anthony Cappa Spielberg, Austin, TX (US)

Correspondence Address: IBM CORPORATION, PO BOX 12195, DEPT YXSA, BLDG 002, RESEARCH TRIANGLE PARK, NC, 27709, US

(21) Appl. No.: 11/291,541

(22) Filed: Dec. 1, 2005

(51) Int. Cl. G10L 15/26

(52) U.S. Cl. 704/235

(57) ABSTRACT

A computer controlled method, with appropriate computer programming support, for providing a visualized outline and index to a meeting of a plurality of individuals comprising recording a sequential audio file of the meeting and identifying each spoken portion of the audio file with one of said plurality of individuals. Then, converting the audio file to a sequential text document and analyzing the sequential text file for selected spoken terminology. At this point, the text document may be sequentially displayed and there is displayed in association with the displayed text document, a sequential annotated graph, running concurrently with said sequential displayed text and visualizing said selected spoken terminology.

### TECHNICAL FIELD

The present invention relates to the visualization and annotation of the content of business and like meetings with several participants on computer controlled display systems.

### BACKGROUND OF RELATED ART

Computers and their application programs are used in all aspects of business, industry and academic endeavors. In recent years, there has been a technological revolution driven by the convergence of the data processing industry with the consumer electronics industry. This advance has been even further accelerated by the extensive consumer and business involvement in the Internet. As a result of these changes, it seems as if virtually all aspects of human productivity in the industrialized world require human/computer interaction. The computer industry has been a force for bringing about great increases in business and industrial productivity.

In addition, the computer and computer related industries have benefitted from a rapidly increasing availability of data processing functions. Along with this benefit comes the problem of how to present the great number and variety of available elements to the interactive operator or user in display interfaces that are relatively easy to use. For many years, display graphs have been a widely used expedient for helping the user to keep track of and to organize and present operative and available functions and elements on computer controlled display systems. Computer displayed graphs have been used to help the user or the user's audience visualize and comprehend presentations from all aspects of technology, business, education and government.

One area in which computer controlled visualization has not yet reached potential of usefulness has been in the visualization and annotation of the recorded content of business meetings. While the traditional meeting where all the participants are in the same room is still extensively practiced, great numbers of such meetings involve at least partial participation through video and teleconferencing. Thus, when in the present description reference is made to business meetings, the term is meant to also include in person, video and teleconference participation in the meeting. Also, business meetings is meant to include meetings relating to technology, education and government. It is, of course, highly important that the essence of the content of these meetings be captured, distilled, annotated and preserved in some form that is useful to the participants in the meeting and other interested parties.

The recording of the content of the meeting as audio files has been conventional. However, the analysis of the audio content and the distillation of such content into topics, weights of topics, terminology of varying importance, weights of contribution of speakers and then into some kind of outline or guide of help to users has been difficult. Such conventional approaches often involve just a comparison of notes of a variety of note takers who are charged with putting together a guide to content involving speakers, annotations and topics. Such techniques have limited usefulness because of time constraints and the limitations of the note takers to have an awareness of all weights of all terminology, topics and speakers.

### SUMMARY OF THE PRESENT INVENTION

The present invention provides a proposed solution to the above stated problem of visualizing an outline of the content of a business meeting with appropriate weights of importance given to terminology, topics and speakers.

The invention is implemented by a computer controlled method, with appropriate computer programming support for providing a visualized outline and index to a meeting of a plurality of individuals comprising recording a sequential audio file of the meeting and identifying each spoken portion of the audio file with one of said plurality of individuals. Then converting the audio file to a sequential text document and analyzing the sequential text file for selected spoken terminology. At this point, the text document may be sequentially displayed, and there is displayed in association with the displayed text document, a sequential annotated graph, running concurrently with said sequential displayed text and visualizing said selected spoken terminology.

The graph may be annotated, when identified speakers are speaking in the audio file with speaker identity along with the text of their speech. In addition, the values represented on the graph are weighted based upon the predetermined significance assigned to the individual speaking the selected terminology.

One aspect of the invention involves assigning predetermined weights to selected terminology and weighting the values represented on the graph based upon said predetermined assigned weights. In addition, the weighted values represented on the graph are further weighted by the predetermined significance assigned to the individual speaking the selected terminology.

There also may be further weighting of the values represented on the graph based upon the frequency with which said selected terminology is spoken in the meeting. This applies even with terminology that is not predetermined or selected for an assigned weight. This aspect involves determining the frequency with which previously unselected terminology is spoken, assigning weights to previously unselected terminology based upon said determined frequency, and weighting the values represented on the graph based upon the weights assigned to said previously unselected terminology.

The present invention also enables determining topics of discussion in the meeting based upon the spoken terminology and annotating the graph with these determined topics of discussion. The invention also enables the mapping and annotating of changes in topics of the discussion on the graph by predetermining a set of transitional spoken terms indicating a change in topics of discussion and annotating the graph to mark such changes in topics of discussion.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view illustrating a meeting attended in person by the participants during which the audio file used by the present invention was recorded with appropriate identification of speakers in the meeting;

FIG. 2 is a block diagram of a interactive data processing display system including a central processing unit that is capable of implementing the programming for converting the meeting audio file to text, analyzing the text and displaying the visualized outline of the content of a business meeting with appropriate weights of importance given to terminology, topics and speakers according to the present invention;

FIG. 3 is a diagrammatic view of a display screen illustrating an annotated graph outlining the course of the meeting with identifying contributions of speakers and mapping the terminology and transitions between topics and scrollable in coordination with the scrollable full sequential text of the meeting;

FIG. 4 is an illustrative flowchart describing the setting up of the elements of a program according to the present invention for conversion and analysis of the audio file recorded at the meeting to generate the content of the annotated graph; and

FIG. 5 is a continued illustrative flowchart illustrating the rendering of the annotated graph embodying the graph content developed by the programming described in FIG. 4.

### DETAILED DESCRIPTION OF THE PREFERRED EMBODIMENT

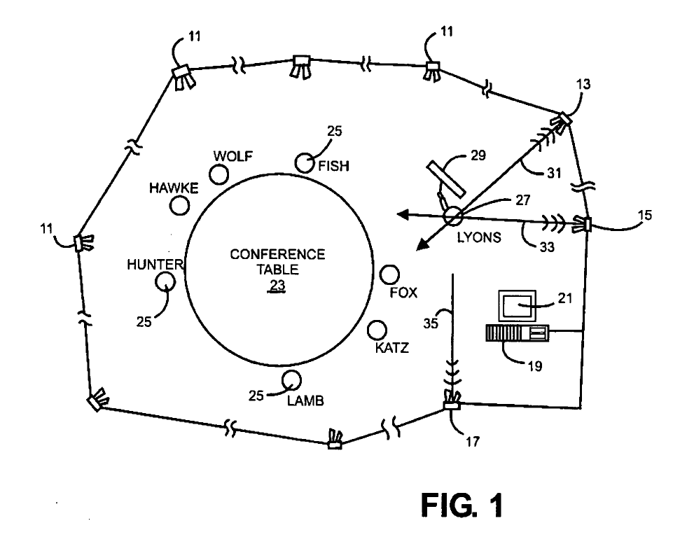

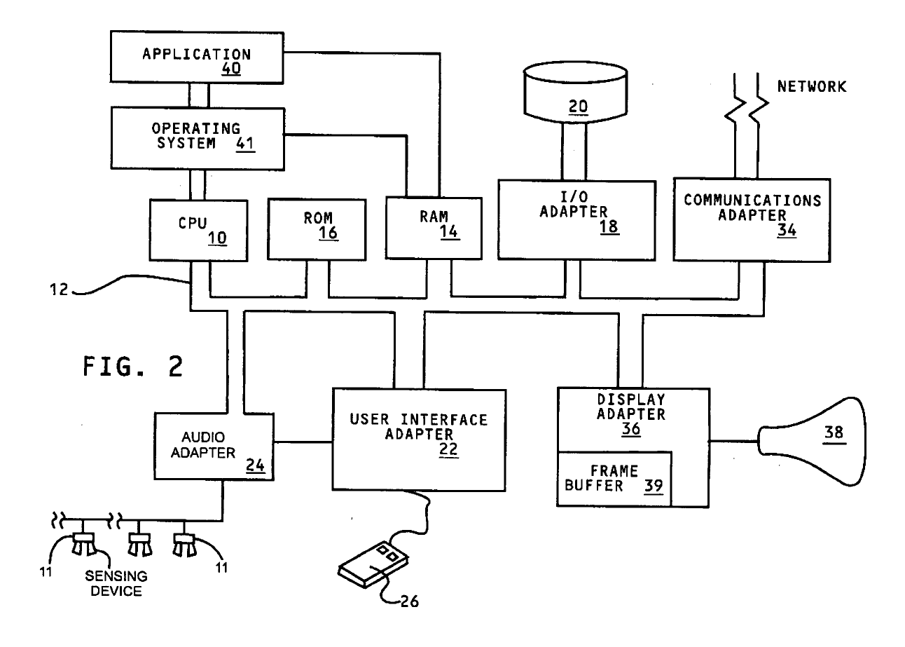

Referring to FIG. 1, is an illustrative conference or business meeting where for simplicity of illustration, the persons 25 attending are shown seated around a conference table 23. There is a presentation in progress by Mr. Lyons 27 at a display board 29. However, any of the attendees 25 may, of course, speak and participate. Arrayed around the room are sound receptors 11 that are connected to computer 19 (subsequently described in FIG. 2) wherein the resulting digital audio file will be converted to a sequential text document as will be described in greater detail. Each of these receptors 11 also has an associated sound direction sensor that enables the speaker Lyons 27 to be identified by triangulation of sensors 13, 15 and 17 via their respective sound direction paths 31, 33 and 35. Defining positions by the triangulation of sound is a known technique, e.g. as described in the publication, Beep: 3D Indoor Positioning Using Audible Sound, Atri Mandal et al., School of Information and Computer Science, University of California, Irvine Calif. August, 2004, available from the Web (www.ics.uci.edu/˜givargis/pubs/C25.pdf). While the speakers in the illustration are identified by triangulation, other methods of identification may used, e.g. voice patterns or if the speakers are in fixed positions around a table, they may be respectively identified by their positions at the table. If the conference is being video recorded, the speakers may be identified through their images. On the other hand, if the meeting has participants who are telecommunicating, these may be identified through their telecommunications identifiers. The point is that the speakers are identified, and this information is included with the audio file.

Referring to FIG. 2, a typical data processing computer controlled display is shown that may function as a basic display 21 computer 19 (of FIG. 1) control used in implementing the present invention for receiving the audio file of the business meeting and providing the computer system enabling the operation of the programming used in the present invention to convert the audio file to a sequential text document, analyzing the meeting content and creating the annotated visualization graph scrollable in correspondence with the scrolling of the sequential text document. A central processing unit (CPU) 10, such as one of the PC microprocessors or workstations, e.g. RISC System/6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 2. Operating system 41 may be one of the commercially available operating systems, such as IBM's AIX 6000™ operating system or Microsoft's WindowsXP™ as well as UNIX and other IBM AIX operating systems. Application programs 40, controlled by the system, are moved into and out of the main memory Random Access Memory (RAM) 14. These programs include the above-mentioned programs of the present invention that will be described hereinafter in greater detail. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices, e.g. mouse 26, are also connected to system bus 12, via user interface adapter 22 and display adapter 36 connects input to display 38. The audio file is developed in the computer via audio input from sensing devices 11 though audio adapter 24. When necessary to relate to the computer programs of this invention, the user may interactively relate to the programs via mouse 26 or any keyboard (not shown). Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through a keyboard or mouse 26 and receiving output information from the system via display 38.

The computer system shown in FIG. 2 may be used to implement the programs of the present invention. Although, in the present illustration, the system of FIG. 2 has been shown to represent the display computer 19 illustrated in FIG. 1. It should be understood that while a computer such as computer 19 is necessary to control the creation of the user file, the actual analysis of the textual content and the creation of the annotated visualization may be done at any remote computer system to which the audio file may be communicated.

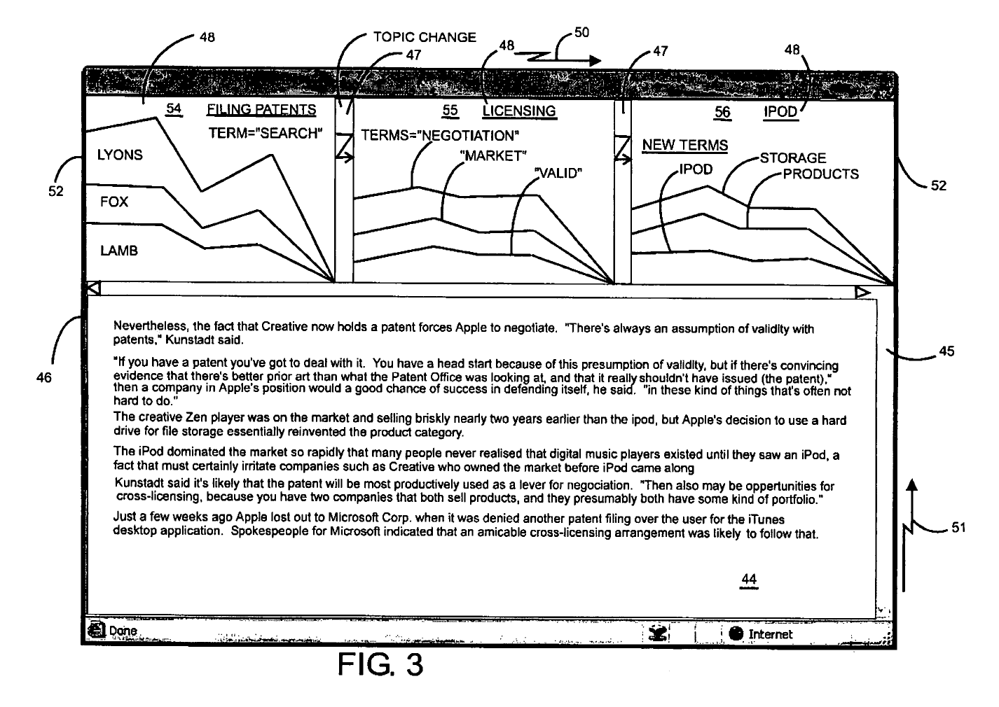

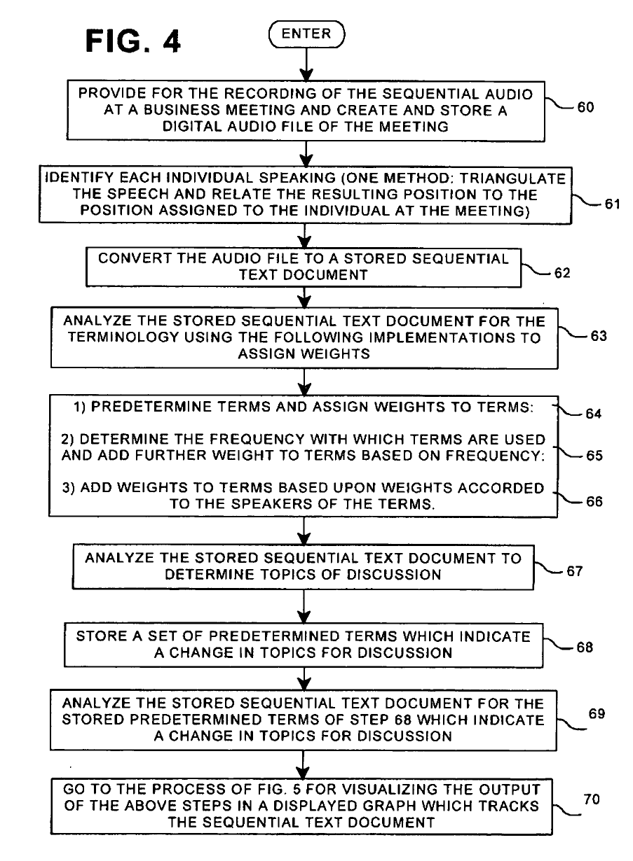

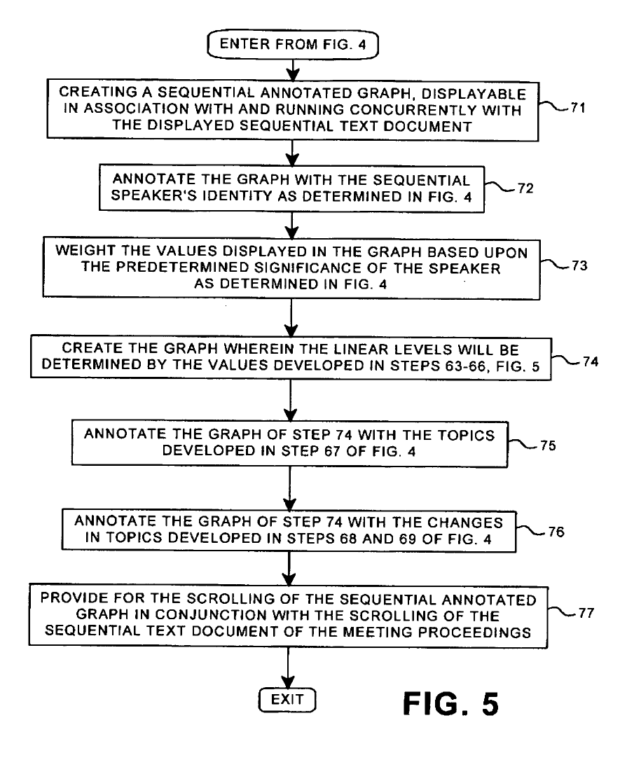

FIG. 3 is a generalized illustrative display screen showing aspects of the present invention. The computer programs for creating the display screens of FIG. 3 will be described in greater detail with respect to FIGS. 4 and 5. However, the display screen of FIG. 3 illustrates several annotative and visualization functions that the present invention is enabled to perform. The sequential text document representative of the full text is shown in window 44 of the display screen. The full text is scrollable in the direction 51 shown through the use of the pointer driven by mouse 26 (FIG. 2) through the convention use of scroll bar 45. Above the text window 44 is window 52 within which the annotated visualized graph content of the textual content below will be scrolled in the direction 50 to correspond to the scrolling of sequential text document in window 44 below. It will be understood that the visualized annotated graph appearing in window may use many implementations to represent the sequential text document of the meeting being scrolled. Some of these implementations are represented in the three segments 54, 55 and 56 of overall visualization that is scrolled in direction 50 in window 52 in general synchronization with the scrolling in direction 51 of the full text sequence in window 44. The meeting being analyzed is discussing the broad topic of patents. Using the programming implementations to be subsequently described, it has been determined that in segment 54 the main topic 48 of discussion was “Filing Patents”; the main topic 48 in segment 55 was “Licensing”; and the main topic in segment 56 was “Ipod”. The transitions or changes between topics shown as segment breaks 47 have also been determined by the programming to be described hereinafter.

Then, for convenience in illustration, each segment shows one of the many different implementations used in accordance with the present invention. In segment 54, there is illustrated a graph for the term “search”. This term was one that was predetermined to be a significant term. The graph illustrates the frequency of the use of the term by three meeting attendees: Fox, Lamb and Lyons. Also, the use of the terms has been weighted so that the contribution of Lyons, the presenter, has been given twice the weight of the others. Thus, in the graph, the contribution of Lyons is already shown as doubled. In segment 55, where the topic has been changed to “Licensing”, the most frequently used of the predetermined terms that the analysis programs were looking for were: “Negotiation”, “Market” and “Valid”. These have been graphed based upon frequency of usage. In the last segment 56 shown, the topic has changed to “Ipod”. In the illustration, the change to this topic for discussion was unanticipated when the predetermined terminology to be monitored was developed. Thus, new terms to be visualized were developed based primarily upon frequency of usage, as will be hereinafter described with respect to the program descriptions of FIGS. 4 and 5. These terms: “Storage, Products, and Ipod” are shown graphed based primarily on frequency of usage.

Now, with reference to FIGS. 4 and 5, we will describe a process implemented by a program according to the present invention for the visualization, i.e. annotated graphing of the contents of the business meeting described with respect to FIGS. 1 through 3. At a business meeting, provision is made for the recording of the sequential audio content of the meeting, as illustrated in FIG. 1, and for the storage of the recorded audio file, step 60. Each speaker at the meeting is identified, step 61, e.g. by the triangulation, previously described with respect to FIG. 1. The audio file is then converted into the stored sequential text document of the complete content of the meeting, step 62. The stored audio file may be subsequently converted to the text of the audio content of the meeting or it may be directly converted into text on a real time basis as the speaking in the meeting continues. In either instance, conventional speech recognition techniques may be used, such as the conventional techniques described in U.S. Pat. No. 6,937,984 (filed Dec. 18, 1998). Next, the stored sequential text document of the full content is analyzed, step 63, so that a graphical outline may be created that visualizes and annotates the graphical content to provide sequential graphical annotated outline that is scrollable in synchronization with the scrolling of the sequential text document as was shown with respect to FIG. 3. In a computer controlled display terminal as described in FIG. 2, there is provided an operating system with a graphics engine, e.g. the graphics/text functions of Windows^{XP}, which, in turn, translates the vectors provided for the areas in a stacked area graph into dynamic pixel arrays providing the annotated stacked graphs shown in FIG. 3. Some of the analytical techniques used are predetermining terms and assigning weights to such terms, step 64. The frequency and extent to which terms are used may be determined and the respective terms may be weighted based on such frequencies of usage, step 65. The terms may be weighted based upon the status of the speaker using the terms, step 66.

The stored sequential text document may also be analyzed to determine topics of discussion, step 67. For example, a concordance of all terms used in the meeting may be created. Then an appropriate algorithm may be applied that associates words and phrases commonly used in various topical areas, thereby identifying blocks of discussion centering around a given topic. Time tracking is, of course, important. If multiple speakers simultaneously use common words that point to a topical area, this, of course, would be given more weight than if only a single speaker were using the term. A set of terms that indicate a change or transition in topics may be predetermined and stored, step 68, e.g. “now, lets talk about” . . . “the next topic is” . . . “we need to discuss”. The presence of such terms in the text content indicates such a transition, step 69, of topics. At this point, the process proceeds to the routines of FIG. 5 for visualizing the output of the above-described steps in a displayed graph that tracks the sequential text document, step 70. Step 71 involves creating a sequential annotated graph that is displayable in association with and runs concurrently with the displayed sequential text document, as shown in FIG. 3. The graph is annotated with the sequential speaker's identities as determined in FIG. 4, step 72. The values displayed in the graph are weighted based upon the predetermined significance of the speakers as determined in FIG. 4, step 73. A graph is created wherein the linear levels will be determined by the values developed in steps 63 through 66 of FIG. 4, step 74. The graph of step 74 is annotated with the topics developed in step 67 of FIG. 4, step 75. The graph of step 74 is annotated with the changes in topics developed in steps 68 and 69 of FIG. 4, step 76. Finally, provision is made for the scrolling of the sequential annotated graph in conjunction with the scrolling of the sequential text document of the meeting proceedings, step 77.

Although certain preferred embodiments have been shown and described, it will be understood that many changes and modifications may be made therein without departing from the scope and intent of the appended claims.

What is claimed is:

1. A computer controlled method for providing a visualized outline and index to a meeting of a plurality of individuals comprising:
recording a sequential audio file of the meeting;
identifying each spoken portion of the audio file with one of said plurality of individuals;
converting the audio file to a sequential text document;
analyzing the sequential text file for selected spoken terminology;
sequentially displaying said text document; and
displaying in association with said text document a sequential annotated graph, running concurrently with said sequential displayed text and visualizing said selected spoken terminology.

2. The method for providing a visualized outline of claim 1 wherein said graph is annotated with the identification of the individual speaking the selected terminology.

3. The method for providing a visualized outline of claim 2 wherein the values represented on the graph are weighted based upon the predetermined significance assigned to the individual speaking the selected terminology.

4. The method for providing a visualized outline of claim 1 further including the steps of:
assigning predetermined weights to selected terminology; and
weighting the values represented on the graph based upon said predetermined assigned weights.

5. The method for providing a visualized outline of claim 4 wherein the weighted values represented on the graph are further weighted by the predetermined significance assigned to the individual speaking the selected terminology.

6. The method for providing a visualized outline of claim 4 including the step of further weighting the values represented on the graph based upon the frequency with which said selected terminology is spoken in the meeting.

7. The method for providing a visualized outline of claim 4 further including the steps of:
determining the frequency with which previously unselected terminology is spoken;
assigning weights to previously unselected terminology based upon said determined frequency; and
weighting the values represented on the graph based upon the weights assigned to said previously unselected terminology.

8. The method for providing a visualized outline of claim 4 further including the steps of:
determining topics of discussion in the meeting based upon the spoken terminology; and
annotating the graph with said determined topics of discussion.

9. The method for providing a visualized outline of claim 8 further including the steps of:
predetermining a set of transitional spoken terms indicating a change in topics of discussion; and
annotating the graph to mark such changes in topics of discussion.

10. A computer controlled display system for providing a visualized outline and index to a meeting of a plurality of individuals comprising:
means for recording a sequential audio file of the meeting;
means for identifying each spoken portion of the audio file with one of said plurality of individuals;
means for converting the audio file to a sequential text document;
means for analyzing the sequential text document for selected spoken terminology;
means for sequentially displaying said text document; and
means for displaying in association with said text document a sequential annotated graph, running concurrently with said sequential displayed text and visualizing said selected spoken terminology.

11. The system of claim 10 further including:
means operable during the meeting for identifying the individual speaking the selected terminology;
means for recording the identity of said individual in said audio file; and
means for annotating the graph with the identity of the individual in association with the spoken terminology.

12. The system of claim 11 wherein the means for recording the audio file of the meeting includes at least three audio recording devices throughout the meeting facility whereby the individual speaking the terminology may be identified through triangulation of the spoken sound direction.

13. The system of claim 11 wherein the values represented on the graph are weighted based upon the predetermined significance assigned to the individual speaking the selected terminology.

14. The system of claim 10 further including:
means for assigning predetermined weights to be selected terminology; and
means for weighting the values represented on the graph based upon said predetermined assigned weights.

15. The system of claim 14 further including:
means for determining the frequency with which previously unselected terminology is spoken;
means for assigning weights to previously unselected terminology based upon said determined frequency; and
means for weighting the values represented on the graph based upon the weights assigned to said previously unselected terminology.

16. A computer program having code recorded of a computer readable medium for displaying, on a computer controlled display, a visualized outline and index to a meeting of a plurality of individuals comprising:
means for recording a sequential audio file of the meeting;
means for identifying each spoken portion of the audio file with one of said plurality of individuals;
means for converting the audio file to a sequential text document;
means for analyzing the sequential text document for selected spoken terminology;
means for sequentially displaying said text document; and
means for displaying in association with said text document a sequential annotated graph, running concurrently with said sequential displayed text and visualizing said selected spoken terminology.

17. The computer program of claim 16 further including:
means operable during the meeting for identifying the individual speaking the selected terminology;
means for recording the identity of said individual in said audio file; and
means for annotating the graph with the identity of the individual in association with the spoken terminology.

18. The computer program of claim 17 wherein the values represented on the graph are weighted based upon the predetermined significance assigned to the individual speaking the selected terminology.

19. The computer program of claim 16 further including:
means for assigning predetermined weights to selected terminology; and
means for weighting the values represented on the graph based upon said predetermined assigned weights.

20. The computer program of claim 19 further including:
means for determining the frequency with which previously unselected terminology is spoken;
means for assigning weights to previously unselected terminology based upon said determined frequency; and
means for weighting the values represented on the graph based upon the weights assigned to said previously unselected terminology.
